(19) United States
(12) Patent Application Publication
(10) Pub. No.: US 2026/0028197 A1
(43) Pub. Date: Jan. 29, 2026

(54) ALUMINUM RAMP

(71) Applicant: Tractor Supply Co. of Texas, LP, Brentwood, TN (US)

(72) Inventors: Brian Kennemer, Columbia, TN (US); Ty Rager, Brentwood, TN (US); Shaoyan Deng, SHAOXING (CN)

(21) Appl. No.: 18/782,201

(22) Filed: Jul. 24, 2024

(51) Int. Cl. B65G 69/30

(52) U.S. Cl. CPC B65G 69/30

(57) ABSTRACT

A ramp includes first and second longitudinal support beams extending in a longitudinal direction, each of the longitudinal support beams being formed from bent aluminum sheet material and having a cross-sectional shape including a laterally outer side wall, a top wall, a bottom wall and a laterally inner longitudinal opening between the top wall and the bottom wall. A plurality of support rungs extend transversely between the support beams, each of the support rungs being formed from bent aluminum sheet material and having a cross-sectional shape including an upper support surface and first and second side walls extending downward from opposite edges of the upper support surface, each of the rungs having first and second ends received through the laterally inner longitudinal openings of the support beams. Each of the support rungs is welded to each of the first and second longitudinal support beams.

### BACKGROUND

### 1. Field of the Disclosure

The present application relates to a ramp structure for loading vehicles onto a trailer or a truck bed.

### 2. Background of the Disclosure

An all-terrain vehicle (ATV) may be loaded onto a pickup truck bed or the bed of a trailer using a pair of loading ramps. Previous ramps have typically been manufactured from extruded aluminum components. In recent years limitations have been placed on the importation of extruded aluminum components as a result of regulatory changes. This has created a need for new structural designs providing similar or superior structural performance without the use of extruded aluminum components.

### SUMMARY

The present disclosure provides a construction for an aluminum ramp wherein each of the components of the ramp are formed from aluminum sheet material which is cut, stamped and bent to the desired shape and then the components are welded together.

In a first embodiment the ramp includes first and second longitudinal support beams extending in a longitudinal direction, each of the longitudinal support beams being formed from bent aluminum sheet material and having a cross-sectional shape including a laterally outer side wall, a top wall, a bottom wall and a laterally inner longitudinal opening between the top wall and the bottom wall. A plurality of support rungs extend transversely between the first and second longitudinal support beams, each of the support rungs being formed from bent aluminum sheet material and having a cross-sectional shape including an upper support surface and first and second side walls extending downward from opposite edges of the upper support surface, each of the rungs having first and second ends received through the laterally inner longitudinal openings of the first and second longitudinal support beams, respectively. Each of the support rungs is welded to each of the first and second longitudinal support beams.

In a further embodiment the ramp includes first and second side rails each formed as a laterally inwardly open channel shaped cross-section including a laterally outer side wall, a top wall, a bottom wall and a laterally inner longitudinal opening between the top wall and the bottom wall. A plurality of rungs extend transversely between the first and second side rails, each of the rungs being formed as a downwardly open channel shaped cross- section, each of the rungs having first and second ends received through the laterally inner longitudinal openings of the first and second side rails, respectively. Each of the rungs is welded to each of the side rails.

In a further embodiment a method of manufacturing such a ramp includes:
forming each of the first and second side rails by cutting a planar rail shape from a sheet of aluminum material and then bending the planar rail shape to form the laterally inwardly open channel shaped cross-section;
forming each of the rungs by cutting a planar rung shape from a sheet of aluminum material and then bending the planar rung shape to form the downwardly open channel shaped cross-section;
inserting the first and second ends of each of the rungs into the laterally inner longitudinal opening of each of the first and second side rails, respectively; and
welding each of the rungs to the first and second side rails

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a schematic rear perspective view showing an ATV loaded into a bed of a pickup truck using a pair of ramps of the present disclosure.

FIG. 2 is a top perspective view of one of the ramps of FIG. 1.

FIG. 3 is a side elevation view of the ramp of FIG. 2.

FIG. 4 is an enlarged cross-section upper perspective view of a portion of the ramp of FIG. 2.

FIG. 5 is an enlarged lower perspective view of a portion of the ramp of FIG. 2.

FIG. 6 is a lower inner perspective view of the upper end portion of the side rail of the ramp seen in FIG. 4.

FIG. 7 is a cross-section view taken along line 7-7 of the side rail of FIG. 6.

FIG. 8 is a top plan view of one of the rungs.

FIG. 9 is a side view of the rung of FIG. 8.

FIG. 10 is an end view of the rung of FIG. 8.

FIG. 11 is a plan view of an upper end cap of the ramp of FIG. 2.

FIG. 12 is a lower side view of the end cap of FIG. 11.

FIG. 13 is an end view of the end cap of FIG. 11.

FIG. 14 is a schematic view of a portion of a planar rail shape to be cut from a sheet of aluminum material.

FIG. 15 is a schematic view of a planar rung shape to be cut from a sheet of aluminum material.

FIG. 16 is a schematic view of a planar end cap shape to be cut from a sheet of aluminum material.

FIG. 17 is a schematic perspective view of an alternative embodiment of a ramp formed from bent aluminum sheet material components.

### DETAILED DESCRIPTION

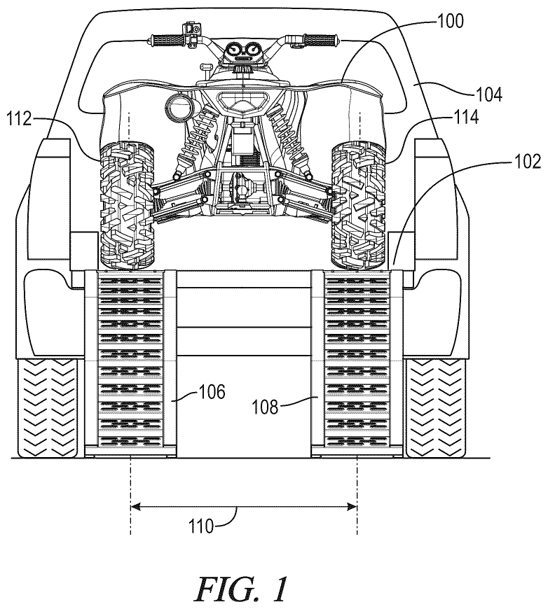

FIG. 1 shows an all-terrain vehicle (ATV) 100 loaded in a bed 102 of a pickup truck 104 using a pair of loading ramps 106 and 108. To load the ATV 100 the ramps 106 and 108 are arranged as shown with a spacing 110 between centerlines of the ramps corresponding to the spacing between centerlines of the wheels 112 and 114 of the ATV. Then the ATV is winched up the ramps into the bed 102 of the truck 104.

The present disclosure is directed to an improved construction of the ramps 106 and 108, which are identical. Thus, the following detailed description of the ramp 106 will be understood to apply equally to both ramps 106 and 108.

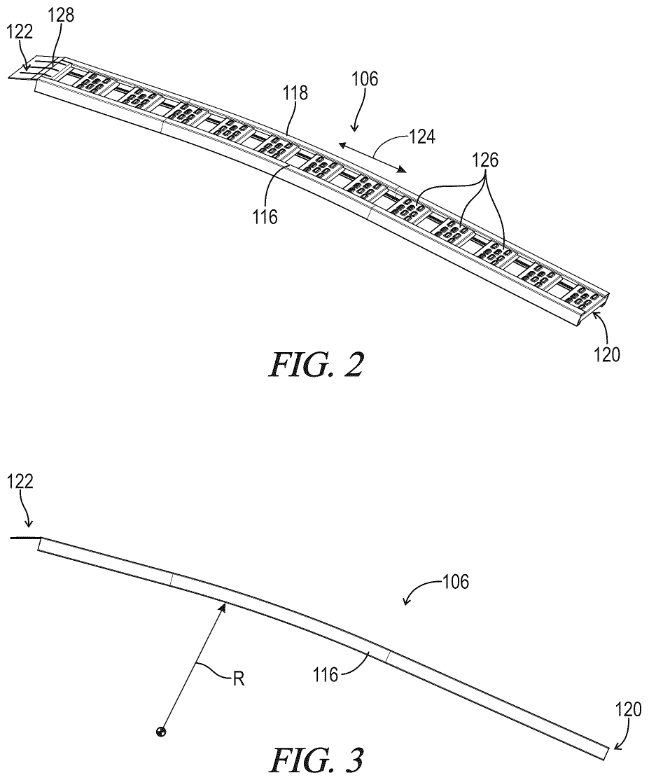

As seen in FIG. 2 the ramp 106 includes first and second longitudinal support beams 116 and 118, each extending in a generally longitudinal direction 124 from a lower end 120 to an upper end 122 of the ramp 106. It will be understood that the longitudinal direction for each of the first and second longitudinal support beams extends along a centerline of the respective beam. The beams and their longitudinal directions may be parallel to each other, but they need not be. It is possible for a width of the ramp 106 or some portion of the ramp 106 to taper, particularly from the lower end 120 towards the upper end 122. The first and second longitudinal support beams 116 and 118 may alternatively be described as first and second side rails 116 and 118.

A plurality of support rungs 126, which may be referred to simply as rungs 126, extend transversely between the first and second longitudinal support beams 116 and 118. An end cap or end rung 128 extends between the first and second longitudinal support beams 116 and 118 adjacent the upper end 122 of the ramp 106.

As best seen in the side elevation view of FIG. 3, each of the first and second longitudinal support beams 116 and 118 and thus the ramps 106 and 108 may form an upwardly convex arch along at least a part of its length. This may be provided by forming a radius R along a portion of the length of the ramp.

As is further described below each of the first and second longitudinal support beams 116 and 118, the rungs 126 and the end cap 128 may be formed from bent aluminum sheet material and then welded together to form the ramp 106.

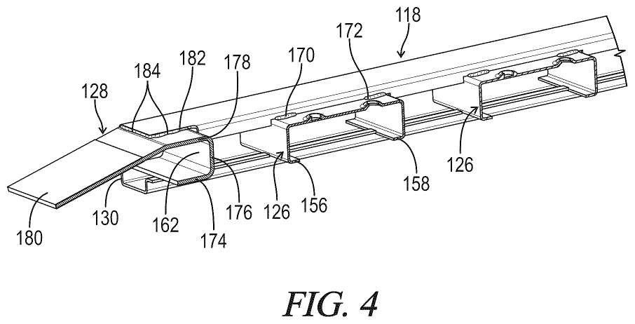

The details of construction of the second longitudinal support beam 118 are best shown in FIGS. 4, 6, 7 and 14. The first longitudinal support beam 116 is a mirror image of the second longitudinal support beam 118. The details of the second longitudinal support beam 118 will be described and it will be understood that those details apply to both longitudinal support beams 116 and 118.

The second longitudinal support beam 118 includes a laterally outer side wall 130, a top wall 132, a bottom wall 134 and a laterally inner longitudinal opening 136 between the top wall 132 and the bottom wall 134. An upper lip 138 extends downwardly from a laterally inner edge 140 of the top wall 132 and terminates in a downwardly directed edge. The upper lip 138 includes a plurality of recesses 139 for receiving upper support surfaces of the rungs as is further described below. A lower lip 142 extends upwardly from a laterally inner edge 144 of the bottom wall 134 and partially closes the laterally inner side of the side rail. The lower lip includes a laterally inward extending flange 146. The lower lip includes a plurality of recesses 148 extending through the laterally inward extending flange 146 for receiving lower rung flanges of the rungs as is further described below.

The cross-sectional shape of the first and second longitudinal support beams 116 and 118 may also be referred to as a laterally inwardly open channel shaped cross-section.

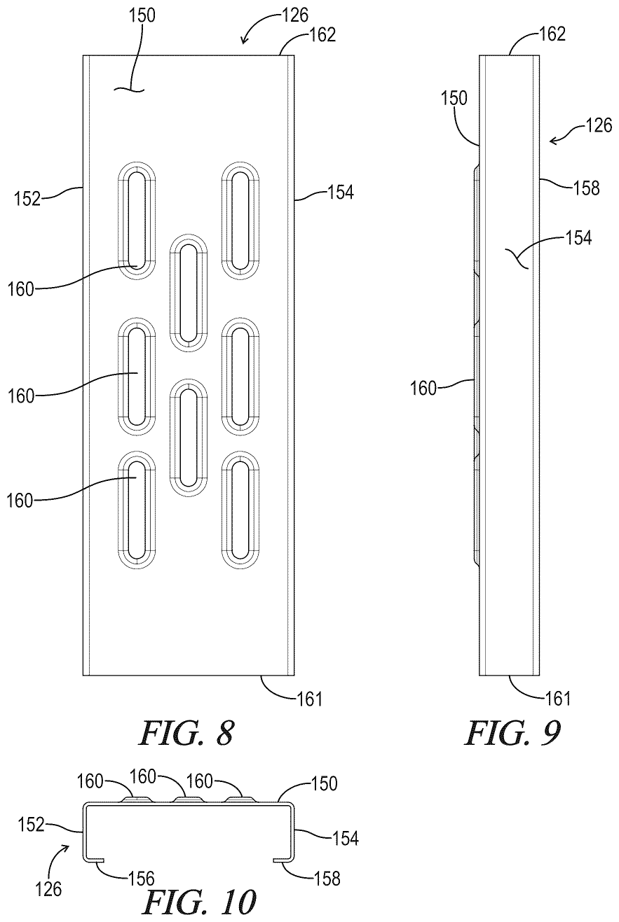

The details of construction of the rungs 126 are best seen in FIGS. 8-10 and 15. As seen in FIG. 10 each of the rungs 126 has a cross-sectional shape including an upper support surface 150 and first and second side walls 152, 154 extending downward from opposite edges of the upper support surface 150. The first and second side walls 152, 154 of each of the support rungs 126 include lower rung flanges 156. 158 extending toward each other. A plurality of raised perforations 160 may be formed in the upper support surface 150 to provide improved traction for the ATV 100 when the same is traversing the ramps 106, 108.

The cross-sectional shape of the rungs 126 may also be referred to as a downwardly open channel shaped cross-section.

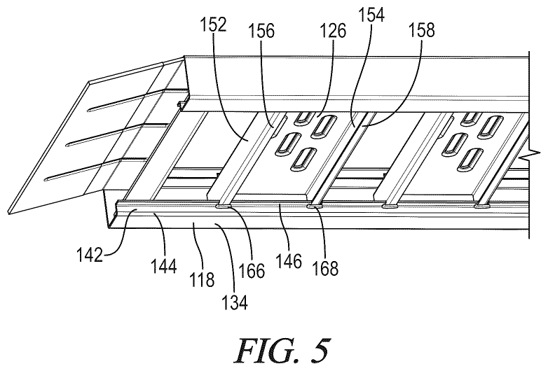

As seen in FIGS. 2, 4 and 5, each of the rungs 126 has first and second ends 161 and 162 received through the laterally inner longitudinal openings 136 of the first and second longitudinal support beams 116 and 118, respectively. As best seen in FIG. 5, the lower rung flanges 156 and 158 of each rung are received in two of the recesses 148 of the lower lip 142 of each of the first and second longitudinal support beams 116 and 118. The two recesses 148 are located opposite one of the recesses 139 formed in the upper lip 138 of each of the first and second longitudinal support beams 116 and 118. Each of the lower rung flanges 156 and 158 may be located at an elevation lower than an adjacent portion of the laterally inward extending flange 146 of the lower lip 142 of each of the first and second longitudinal support beams 116 and 118. The lower rung flanges 156 and 158 may be welded to the lower lip 142 by fillet welds 166 and 168 as seen in FIG. 5. The rung ends 161 and 162 may engage the laterally outer side walls 130 of the side rails 116 and 118.

As can best be appreciated in viewing FIG. 4, the first and second longitudinal support beams 116 and 118 and the support rungs 126 are dimensioned such that the first and second ends 161 and 162 of each of the support rungs 126 are closely received through the laterally inner longitudinal openings 136 of the first and second longitudinal support beams 116 and 118 with the first and second ends 161 and 162 of each of the support rungs 126 abutting the laterally outer side wall 130 of the first and second longitudinal support beams 116 and 118, respectively. The upper support surface 150 may be welded to the upper lip 138 of each of the first and second longitudinal support beams 116 and 118 by a pair of fillet welds such as 170 and 172.

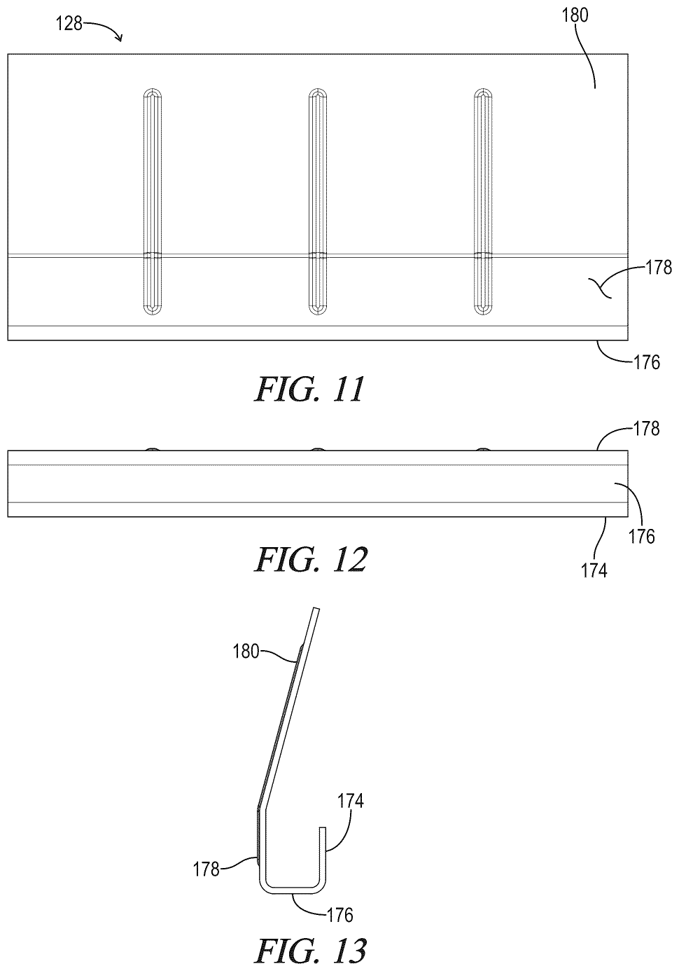

The details of construction of the end cap 128 are best seen in FIGS. 4 and 11-13. The end cap 128 extends transversely between the first and second longitudinal support beams 116 and 118 adjacent to the upper longitudinal end 122 of the ramp and the support beams. As best seen in FIG. 13 the end cap 128 has a cross-section shape including a bottom wall 174, a side wall 176, a top wall 178 and a mounting tongue 180. The mounting tongue 180 extends longitudinally past the upper ends of the support beams 116 and 118 for mounting the ramp 106 on a supporting surface of a truck or trailer bed 102.

As can be seen in FIG. 4, the bottom wall 174, side wall 176 and top wall 178 form a C-shape channel that is received in a recess 182 formed in the top wall 132 and upper lip 138 of the first and second longitudinal support beams 116 and 118 adjacent their upper ends. The end cap 128 may be welded to the top wall 132 by a fillet weld 184.

### Methods of Manufacture

As noted above each of the first and second longitudinal support beams 116 and 118, the rungs 126 and the end cap 128 may be formed from bent aluminum sheet material and are then welded together to form the ramp 106.

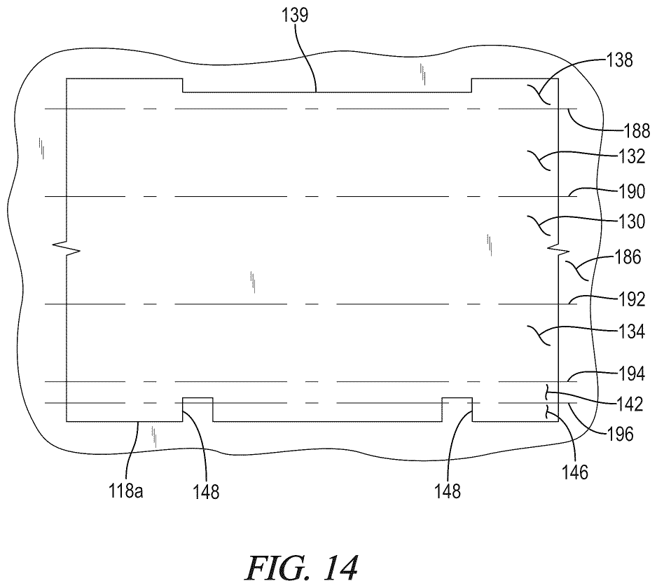

As is illustrated in FIG. 14, each of the first and second longitudinal support beams or side rails 116 and 118 may be formed by first cutting a planar beam shape such as 118a from a sheet 186 of aluminum material. In FIG. 14 the outline of the planar shape is shown in solid lines and may for example be cut with a computer controlled laser jet cutting machine. Only a portion of the total length of the planar shape 118a is shown. As seen in FIG. 14 the recesses 139 and 148 for the upper and lower lips 138 and 142 may be cut in the planar shape 118a.

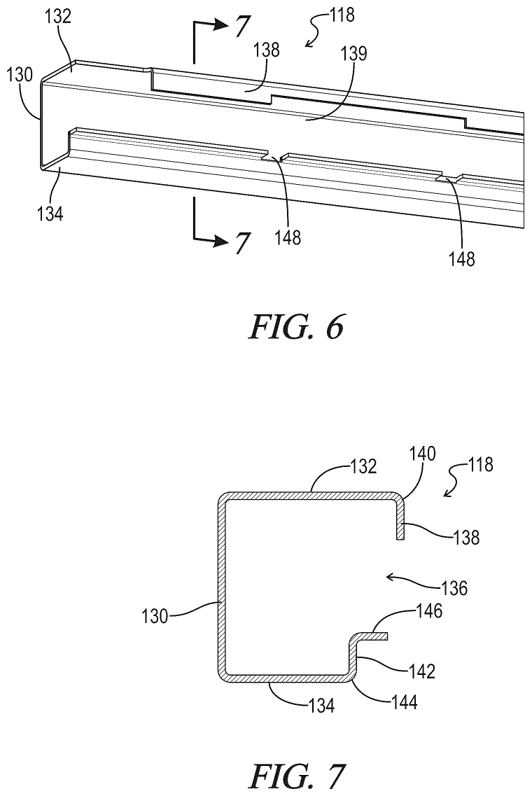

Then the longitudinal support beam 116 or 118 is formed by bending the planar shape 118a to form the beam shown in FIGS. 6 and 7. The bending may be performed with a conventional sheet metal brake machine. A first 90 degree bend between upper lip 138 and upper support surface 132 may be formed at break line 188 shown as a broken line. A further 90 degree bend between the upper support surface 132 and the laterally outer wall 130 may be formed at break line 190. A further 90 degree bend between laterally outer wall 130 and bottom wall 134 may be formed at break line 192. A further 90 degree bend between bottom wall 134 and lower lip 142 may be formed at break line 194. A further 90 degree bend between lower lip 142 and its laterally inward extending flange 146 may be formed at break line 196.

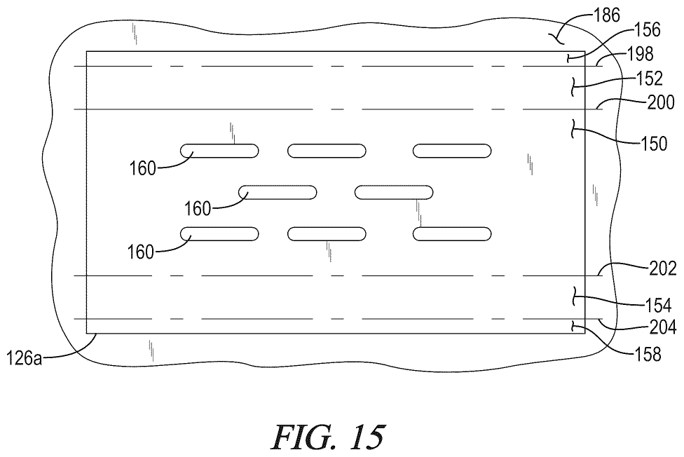

Similarly, as shown in FIG. 15, each of the rungs 126 may be formed by first cutting a planar rung shape 126a from the sheet 186 of aluminum material. The raised perforations 160 may also be punched and/or stamped into the upper support surface 150.

Then each rung 126 is formed by bending the planar rung shape 126a to form the rung shown in FIGS. 8-10. A first 90 degree bend between the first rung flange 156 and the first side wall 152 may be formed at break line 198. A further 90 degree bend between first side wall 152 and upper support surface 150 may be formed at break line 200. A further 90 degree bend between upper support surface 150 and second side wall 154 may be formed at break line 202. A further 90 degree bend between second side wall 154 and second rung flange 158 may be formed at break line 204.

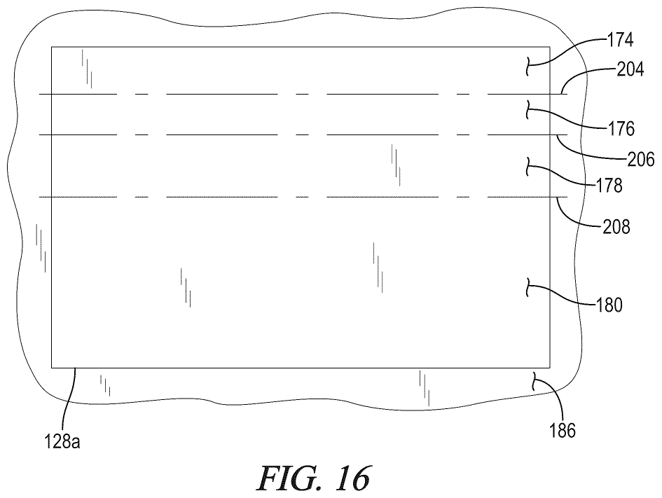

Similarly as shown in FIG. 16, the end cap 128 may be formed by first cutting a planar end cap shape 128a from the sheet 186 of aluminum material. Then the planar end cap shape 128a may be bent to form the end cap 128. A first 90 degree bend between the bottom wall 174 and the side wall 176 may be formed at break line 204. A further 90 degree bend may be formed between the side wall 176 and the top wall 178 at break line 206. A further bend of between 15 to 25 degrees may be formed between the top wall 178 and the tongue 180 at break line 208.

After each of the components 116, 118, 126 and 128 have been formed they may be assembled as shown in FIG. 4 by inserting the first and second ends 161 and 162 of each of the rungs 126 into the laterally inner longitudinal opening 136 of each of the side rails 116 and 118, and then welding the components together as previously described.

In one embodiment the aluminum sheet material 186 used to form the components may be a 5052 aluminum alloy material. The sheet material for forming the longitudinal support beams 116 and 118 may be 13 gage material having a thickness of about 1.8 mm (0.072 inch). The sheet material for forming the rungs 126 and the end cap 128 may be 14 gage material having a thickness of about 1.6 mm (0.064 inch).

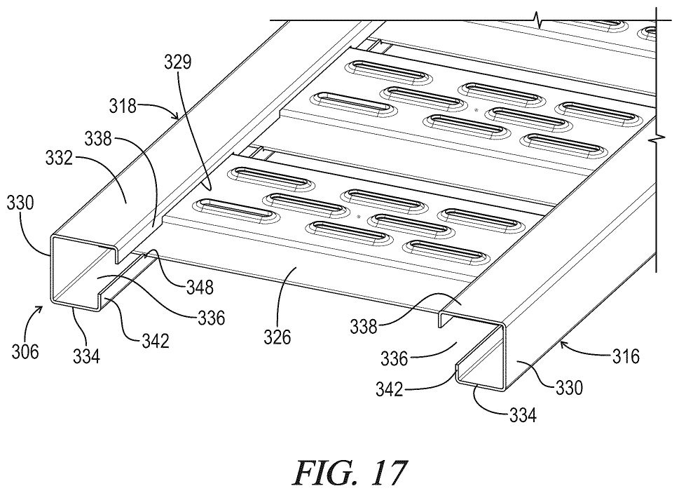

### Alternative Embodiment of FIG. 17

FIG. 17 shows an alternative embodiment of the disclosed ramp designated by the number 306. The ramp 306 includes side rails 316 and 318 formed from bent aluminum sheet material to define laterally inwardly open channel shapes. Each side rail includes a laterally outer side wall 330, a top wall 332, an upper lip 338, a bottom wall 334 and a lower lip 342. A laterally inner longitudinal opening 336 is formed between the upper lip 338 and lower lip 342. A plurality of rungs 326 extend between the side rails 316 and 318. Each of the rungs 326 is formed in a manner similar to the rungs 126 described above. The rungs 326 are received in recesses 329 and 348 formed in the upper and lower ips 338 and 342. All of the components are welded together.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A ramp, comprising:
first and second longitudinal support beams extending in a longitudinal direction, each of the longitudinal support beams being formed from bent aluminum sheet material and having a cross-sectional shape including a laterally outer side wall, a top wall, a bottom wall and a laterally inner longitudinal opening between the top wall and the bottom wall;
a plurality of support rungs extending transversely between the first and second longitudinal support beams, each of the support rungs being formed from bent aluminum sheet material and having a cross-sectional shape including an upper support surface and first and second side walls extending downward from opposite edges of the upper support surface, each of the rungs having first and second ends received through the laterally inner longitudinal openings of the first and second longitudinal support beams, respectively; and
wherein each of the support rungs is welded to each of the first and second longitudinal support beams.

2. The ramp of claim 1, wherein:
each of the first and second longitudinal support beams further includes an upper lip extending downwardly from a laterally inner edge of the top wall;
each of the first and second longitudinal support beams further includes a lower lip extending upwardly from a laterally inner edge of the bottom wall;
the upper lip includes a plurality of recesses for receiving the upper support surfaces of the support rungs; and
the lower lip includes a plurality of recesses for receiving the first and second walls of each of the support rungs.

3. The ramp of claim 2, wherein:
the lower lip of each of the first and second longitudinal support beams includes a laterally inward extending flange and the recesses of the lower lip extend through the laterally inward extending flange.

4. The ramp of claim 3, wherein:
the first and second longitudinal support beams and the support rungs are dimensioned such that the first and second ends of each of the support rungs are closely received through the laterally inner longitudinal openings of the first and second longitudinal support beams with the first and second ends of each of the support rungs abutting the laterally outer side wall of the first and second longitudinal support beams, respectively.

5. The ramp of claim 3, wherein:
the first and second side walls of each of the support rungs include lower rung flanges extending toward each other, the lower rung flanges being received in the recesses of the lower lip.

6. The ramp of claim 5, wherein:
each of the lower rung flanges is located at an elevation lower than an adjacent portion of the laterally inward extending flange of the lower lip of each of the first and second longitudinal support beams.

7. The ramp of claim 5, wherein:
each of the lower rung flanges is welded to the lower lip of each of the first and second longitudinal support beams.

8. The ramp of claim 7, wherein:
The upper support surface of each of the support rungs is welded to the upper lip of each of the first and second longitudinal support beams.

9. The ramp of claim 1, wherein:
each of the first and second longitudinal support beams forms an upwardly convex arch along at least part of its length.

10. The ramp of claim 1, further comprising:
an end cap extending between the first and second longitudinal support beams adjacent one longitudinal end of the support beams, the end cap including a mounting tongue extending longitudinally past the support beams for mounting the ramp on a supporting surface of a truck or trailer bed, the end cap being formed from bent aluminum sheet material and having a cross-sectional shape including a top wall, the mounting tongue extending from a first edge of the top wall, a downward extending side wall extending from a second edge of the top wall opposite from the first edge, and a bottom wall extending longitudinally from the downward extending side wall.

11. A ramp, comprising:
first and second side rails each formed as a laterally inwardly open channel shaped cross-section including a laterally outer side wall, a top wall, a bottom wall and a laterally inner longitudinal opening between the top wall and the bottom wall;
a plurality of rungs extending transversely between the first and second side rails, each of the rungs being formed as a downwardly open channel shaped cross-section, each of the rungs having first and second ends received through the laterally inner longitudinal openings of the first and second side rails, respectively; and
wherein each of the rungs is welded to each of the first and second side rails.

12. The ramp of claim 11, wherein:
each of the first and second side rails includes a downwardly extending upper lip and an upwardly extending lower lip partially closing a laterally inner side of the side rail.

13. The ramp of claim 12, wherein:
the upper lip and the lower lip of each of the first and second side rails include recesses for receiving the rungs.

14. The ramp of claim 13, wherein:
each of the rungs is welded to the upper and lower lips of each of the first and second side rails.

15. The ramp of claim 11, wherein:
each of the rungs engages the laterally outer side wall of each of the first and second side rails.

16. The ramp of claim 11, wherein:
the downwardly open channel shaped cross-section of each of the rungs includes an upper support surface, first and second side walls extending downward from opposite edges of the upper support surface, and lower rung flanges of the first and second side walls extending toward each other.

17. The ramp of claim 16, wherein:
the laterally inwardly open channel shaped cross-section of each of the side rails includes an upper lip extending downwardly from a laterally inner edge of the top wall and terminating in a downwardly directed edge;
the laterally inwardly open channel shaped cross-section of each of the side rails includes a lower lip extending upwardly from a laterally inner edge of the bottom wall, the lower lip including a laterally inward extending flange;
the upper lip includes a plurality of recesses defined therein, each of the recesses of the upper lip being dimensioned to receive the upper support surface of one of the rungs therein; and
the lower lip includes a plurality of recesses defined therein through the laterally inward extending flange, each of the recesses of the lower lip being dimensioned to receive a lower rung flange of one of the side walls of one of the rungs therein.

18. The ramp of claim 17, wherein:
the upper support surface of each of the rungs is welded to the upper lip of each of the first and second side rails; and
the lower rung flanges of each of the rungs are welded to the lower lip of each of the first and second side rails.

19. A method of manufacturing the ramp of claim 11, comprising:
forming each of the first and second side rails by cutting a planar rail shape from a sheet of aluminum material and then bending the planar rail shape to form the laterally inwardly open channel shaped cross-section;
forming each of the rungs by cutting a planar rung shape from a sheet of aluminum material and then bending the planar rung shape to form the downwardly open channel shaped cross-section;
inserting the first and second ends of each of the rungs into the laterally inner longitudinal opening of each of the first and second side rails, respectively; and
welding each of the rungs to the first and second side rails.

20. The method of claim 19, wherein:
the forming of each of the first and second side rails includes forming the laterally inwardly open channel shaped cross-section to include an upper lip extending downwardly from a laterally inner edge of the top wall and terminating in a downwardly directed edge;
the forming of each of the first and second side rails includes forming the laterally inwardly open channel shaped cross-section to include a lower lip extending upwardly from a laterally inner edge of the bottom wall, the lower lip including a laterally inward extending flange; and
the welding includes welding each of the rungs to the upper and lower lips of each of the first and second side rails.
